(19) United States
(12) Patent Application Publication
(10) Pub. No.: US 2017/0311137 A1
(43) Pub. Date: Oct. 26, 2017

(54) MOVIE NIGHT

(71) Applicant: THOMSON LICENSING, Issy les Moulineaux (FR)

(72) Inventors: Samantha Jane BENNETT, Seattle, WA (US); Subrahmanya Sandilya BHAMIDIPATI, Palo Alto, CA (US)

(21) Appl. No.: 15/520,591

(22) PCT Filed: Nov. 4, 2015
(86) PCT No.: PCT/US2015/058983

§ 371 Date: Apr. 20, 2017

Related U.S. Application Data
(60) Provisional application No. 62/077,490, filed on Nov. 10, 2014.

(51) Int. Cl. H04W 4/20; G06Q 10/10; H04W 4/00; H04W 4/02

(52) U.S. Cl. CPC H04W 4/206; H04W 4/02; G06Q 10/10; H04W 4/008

(57) ABSTRACT

A system uses physical proximity and at least one existing database, e.g., a social network, to provide a group recommendation, such as a movie recommendation, to a group of users without any user interaction. Physical proximity is enabled by devices supporting detection of a beacon from a beacon broadcasting device. Each device separately communicates with the server, which forms the group and which provides a group recommendation based upon information for the group.

### BACKGROUND OF THE INVENTION

The present invention generally relates to devices associated with individual users, such as but not limited to, a mobile phone, tablet, a personal computer (desktop or laptop), etc., for providing group based recommendations to a group of users.

Currently there is a wide assortment of streaming video services, usually with some sort of recommendation system that suggests new films and television (TV) shows for a given user. These systems can make recommendations based on the details of the associated account (which may be shared in the household or limited to a primary account holder). Similarly, there are systems that can provide a group recommendation for a number, or group, or users. However, again, some of these group recommendation systems generally make recommendations based only on the details of one account and those details have to be updated to take into account the likes, or dislikes, of the various users in the group.

There are other variations for providing a group recommendation to a group of users as illustrated by WO 2014/009400. In WO 2014/009400, the device of one user (originating device/user) attempts to detect nearby devices of other users. Each detected device then transmits data for that associated user to the originating device. The originating device aggregates all the data for the group and sends the aggregated data to a server, which forms a group recommendation that is sent by the server back to the originating device. The server may also access a social network for additional data on each user in the group in forming the group recommendation.

Another illustration of a group recommendation system is provided by US 2013/0150086. In this system, a device associated with one user (originating user) sends a group recommendation request to a server, where the group recommendation request identifies the other users in the group and provides location information for at least one member of the group. The server uses stored data for each identified user of the group and the location information to provide the group recommendation back to the originating user.

Unfortunately, the above-described group recommendation systems may have some security and privacy issues. For example, the system described in WO 2014/009400 needs each user to transmit information to, or interact with, the originating user, so there is no guarantee of security and privacy for those users that are not the originating user. In addition, both WO 2014/009400 and US 2013/0150086 describe systems where users in the group depend upon the originating user for communication with the server. In other words, if the originating user leaves the group then the group ceases to exist and functionality is lost.

### SUMMARY OF THE INVENTION

To improve the security and privacy of a group recommendation system and to provide a seamless mechanism for creation of a group and maintenance of the group, a system, in accordance with the principles of the invention, uses physical proximity, a server and at least one existing database, e.g., a social network, to provide a group recommendation for a group of users without any user interaction. Illustratively, physical proximity is enabled by devices supporting detection of a beacon from a beacon broadcasting device. Each device separately communicates with the server, which forms an ad hoc group based upon the beacon, and which provides a group recommendation based upon information for the group.

In an illustrative embodiment of the invention, a device associated with a user comprises: a detector for detecting a beacon, the beacon signaling a group recommendation application; a processor for executing the group recommendation application to send information from the device to a server, the information identifying the user and the beacon; and a receiver for receiving a group recommendation from the server, wherein the group recommendation is associated with likes and/or dislikes of the user as well as of other users that have detected the beacon.

In another illustrative embodiment of the invention, a user's device performs the following method for providing a group recommendation: detecting, in a device associated with a user, a beacon, which signals a group recommendation application; executing the group recommendation application to send information from the device to a server, the information identifying the user and the beacon; and receiving in the device from the server the group recommendation, wherein the group recommendation is associated with likes and/or dislikes of the user as well as of other users that have detected the beacon.

In another illustrative embodiment of the invention, a server performs the following method for providing a group recommendation: receiving information from a first user, the received information indicating detection of a broadcasting beacon associated with a group recommendation service; associating the first user with a broadcast group, the broadcast group being associated with the broadcasting beacon; retrieving preferences for each user in the broadcast group from at least one database; forming a group recommendation from the retrieved preferences; and notifying each user of the group that new recommendations are available (to be obtained automatically by the application).

In another illustrative embodiment of the invention, a server provides a group recommendation service, the server comprising: a receiver for receiving information from a first user, the received information indicating detection of a broadcasting beacon associated with a group recommendation service; and a processor for (1) associating the first user with a broadcast group, the broadcast group being associated with the broadcasting beacon, (2) retrieving preferences for each user in the broadcast group from at least one database, and (3) forming a group recommendation from the retrieved preferences for transmission to each user in the broadcast group.

In accordance with the principles of the invention, the group recommendation is illustratively a movie recommendation.

In view of the above, and as will be apparent from reading the detailed description, other embodiments and features are also possible and fall within the principles of the invention.

### BRIEF DESCRIPTION OF THE DRAWINGS

FIG. 1 shows an illustrative system in accordance with the principles of the invention;

FIG. 2 shows a portion of the beacon data for use in the system of FIG. 1;

FIG. 3 shows an illustrative device for use in the system of FIG. 1;

FIGS. 4-7 show illustrative flow charts for use in a user device in the system of FIG. 1;

FIG. 8 shows an illustrative server in accordance with the principles of the invention;

FIGS. 9-12 show illustrative flow charts for use in server 220 of FIG. 1; and

FIGS. 13 and 14 illustrate group recommendations in the context of movies.

### DETAILED DESCRIPTION

Other than the inventive concept, the elements shown in the figures are well known and will not be described in detail. For example, other than the inventive concept, a set-top box, server, smart phone, tablet, portable music device, personal computer and the components thereof, such as a transceiver (communications block), processor, etc., are well known and not described in detail herein. In addition, other than the inventive concept, familiarity with Bluetooth® Low Energy (BLE, also known as Bluetooth Smart) devices and iBeacon™ location and proximity detection technology is assumed and not described herein. Further, other than the inventive concept, familiarity with networking and social media is assumed and not described herein. It should also be noted that the inventive concept may be implemented using conventional programming techniques, e.g., APIs (application programming interfaces) which, as such, will not be described herein. Finally, like-numbers on the figures represent similar elements.

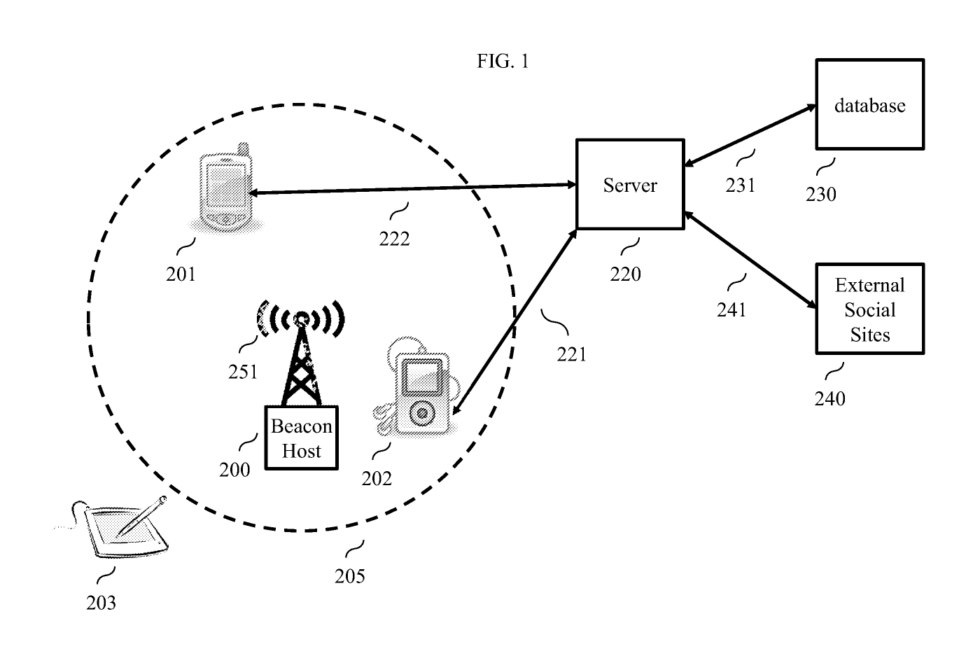

An illustrative group recommendation system in accordance with the principles of the invention is shown in FIG. 1. The group recommendation system comprises a beacon host 200, one or more user devices as represented by mobile device 201 (e.g., a smart phone), mobile device 202 (e.g., an ipod® mobile digital device) and mobile device 203 (e.g., a tablet); a server 220 and at least one source of user information as represented by database 230 and external social sites 240 (e.g., Facebook® social network). In this context, the term database as used herein also includes access to data stored in a social network such as, but not limited to, Facebook. In other words, external social sites 240 are also representative of one, or more, databases, e.g., Google+™ social service. It should be noted that although different mobile devices are illustrated in FIG. 1, the inventive concept is not limited to mobile devices and a device in accordance with the principles of the invention can, e.g., be implemented in non-mobile devices, e.g., a desktop computer, settop box, TV set, game console, jukebox, etc.

Beacon host 200 broadcasts a beacon 251. For illustration purposes only, beacon 251 is in compliance with Apple's iBeacon location and proximity detection technology utilizing Bluetooth Smart (e.g., see Bluetooth 4.0 Specification or later). However, it should be noted that other implementations besides iBeacon location and proximity detection technology are also possible that utilize Bluetooth Low Energy. Other than the inventive concept, as known in the art beacon 251 covers a general physical proximity around Beacon Host 200. In FIG. 1, the general physical area covered by beacon 251 is represented as that area inside the dashed circle 205. (It should be noted that FIG. 1 is not to scale.) Devices located outside of dashed circle 205 should not detect the beacon, as they are out of the broadcast range of the Bluetooth signal. As illustrated in FIG. 1, mobile device 201, and mobile device 202 are within circle 205 and, as such, are close enough in physical proximity to Beacon Host 200 to detect the broadcast beacon. However, mobile device 203 is outside dashed circle 205 and, as such, should not detect the beacon broadcast by Beacon Host 200. The later can be implemented in any number of ways and can come in a variety of form factors such as, but not limited to, small coin cell and AA powered devices, USB sticks, and software versions using Bluetooth 4.0 capable USB dongles. For example, Beacon Host 200 can be incorporated as part of a settop box, such as a Roku® streaming device having an beacon, be an independent device, or be a specific mode of a mobile application running, e.g., on another mobile device. Whether Beacon Host 200 is incorporated into another apparatus or is an independent device is irrelevant to the inventive concept.

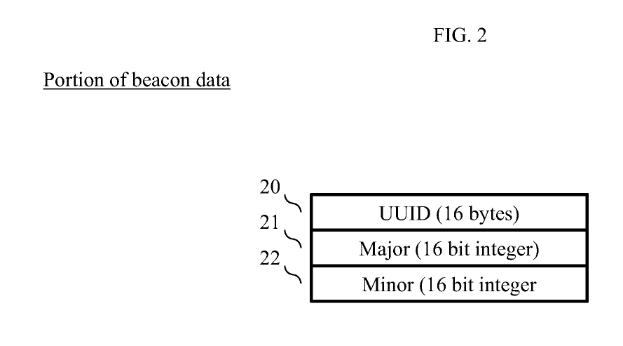

Other than the inventive concept, as known in the art a beacon signal broadcasts a limited amount of data. The relevant data for the purposes of this example is shown in FIG. 2 and is UUID 20, Major 21 and Minor 22. UUID 20 is representative of a first identifying element and is 16 bytes long and the value of UUID 20 is associated a priori with the group recommendation service described herein. In other words, the value of UUID 20 uniquely identifies the group recommendation service from other applications that utilize a beacon. Major 21 and Minor 22 are each 16 bit integers, the combined value of which is representative of a second identifying element that is used to logically identify, or label, the area covered by Beacon Host 200. It should be noted that the physical area covered by Beacon Host 200 can easily be changed by simply moving Beacon Host 200 to another physical location. In other words, the system is not linked to any specific physical location, only where a beacon is physically placed.

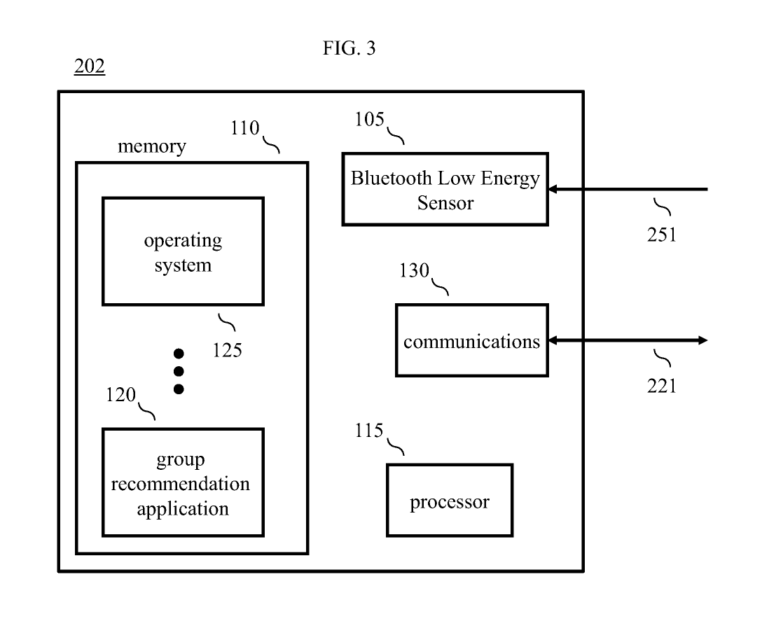

Turning briefly to FIG. 3, an illustrative high level block diagram of a user device in accordance with the principles of the invention is shown for mobile device 202. Only those portions relevant to the inventive concept are shown. As such, a user device in accordance with the principles of the invention can perform other functions, e.g., a settop box. Mobile device 202 is a processor based system as represented by processor 115. The latter represents one, or more, stored-program controlled processors as known in the art. In other words, processor 115 executes programs stored in memory 110. The latter represents volatile and/or non-volatile memory, e.g., hard disk, CD-ROM, DVD, random access memory (RAM), etc.) for storing program instructions and data, e.g., for performing the illustrative methods described further below. In this context, mobile deice 202 executes the operating system 125 (e.g., iOS7 (iphone operating system 7)), which has beacon support, and also stores the group recommendation application 120 (described below). Mobile device 202 also has communications block 130, which supports communications of data over a data connection 221 as known in the art. Data communications can be wired, or wireless, utilizing 802.11, 3G LTE, 4G LTE, etc. Finally, mobile device 202 includes Bluetooth low energy sensor 105 (hereafter sensor 105) for detecting any broadcast beacons. In this example, sensor 105 notifies operating system 125 upon detection of beacon 251 from Broadcast Host 200 when mobile device 202 moves into the broadcast area for Beacon Host 200 and passes the above-mentioned beacon data representing the values of the received UUID 20, Major 21 and Minor 22 to operating system 125.

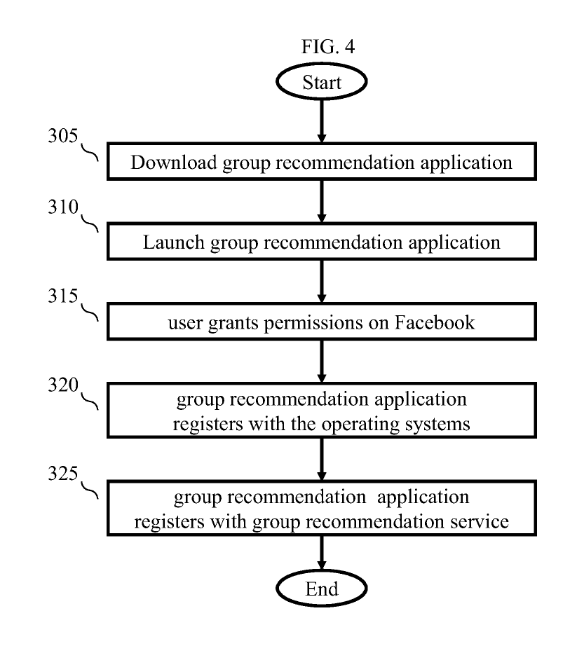

Illustratively group recommendation application 120 is a mobile application and is quite minimal An illustrative flow chart for use in installing and implementing group recommendation application 120 is shown in FIG. 4. A user (e.g., the user of mobile device 202) downloads the group recommendation application 120 from an application store, e.g., the iTunes® store, in step 305. In step 310, the user then launches the group recommendation application 120. In step 315, the group recommendation application 120 prompts the user to sign into Facebook and grant the application permissions to read the user's liked videos and viewing history. In step 320, group recommendation application 120 initiates a search for Bluetooth devices having the UUID registered to the group recommendation service. For example, in the context of iOS7, group recommendation application 120 registers with operating system 125 to look for the Bluetooth devices, whereas in the context of the Android™ platform, group recommendation application 120 creates a background service that looks for the Bluetooth devices. Finally, in step 325, group recommendation application 120 communicates with the group recommendation service (described further below) running on server 220. Illustratively, group recommendation application 120 sends to server 220 identification of the user, a device token associated with mobile device 202 to register mobile 202 (e.g., for push notifications) and the user's Facebook information so that the group recommendation service has the option to fetch any user data pro-actively.

Generally speaking, after a device has installed group recommendation application 120 as described above, as that device enters/leaves the range of the Beacon, the device registers/deregisters with server 220 which supports the group recommendation service. Server 220 then appropriately updates the database for that beacon group, and retrieves relevant information from various social networks (if such data hasn't already been stored) based upon the users in the beacon group. Server 220 then generates recommendations for that beacon group, stores the generated recommendations, and sends a push notification to the devices registered to the beacon group to fetch the new content. Server 220 also is responsible for notifying the individual devices of a beacon group when other users enter/leave the beacon group.

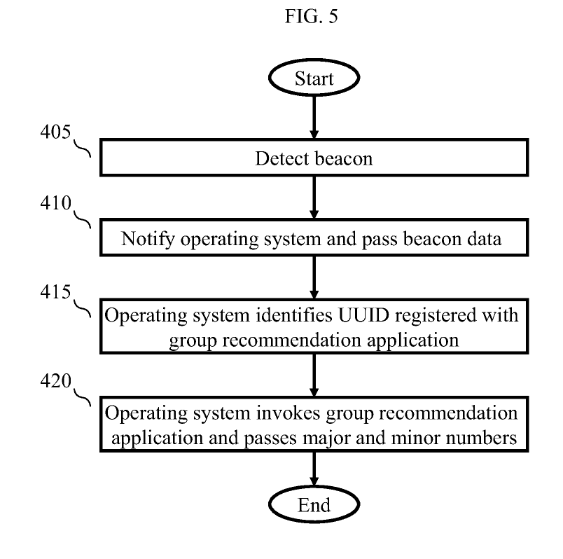

In this context, various flow charts will now be described in the context of mobile device 202 of FIG. 1, and they similarly apply to mobile device 201 and mobile device 203 of FIG. 1. A flow chart in accordance with the principles of the invention for use in a user's device that supports detecting a beacon and has the group recommendation application 120 is shown in FIG. 5. The flow chart of FIG. 5 relates to when a user's device first enters the range of a beacon associated with the group recommendation service. When mobile device 202 enters the range of beacon 251 of FIG. 1, sensor 105 detects beacon 251 in step 405. In step 410, sensor 105 notifies operating system 125 and passes along the received beacon data to operating system 125 in step 410. In step 415, operating system 125 identifies the value of the received UUID as being registered with group recommendation application 120. Finally, in step 420, operating system 125 invokes group recommendation application 120 and passes along the received beacon data to group recommendation application 120.

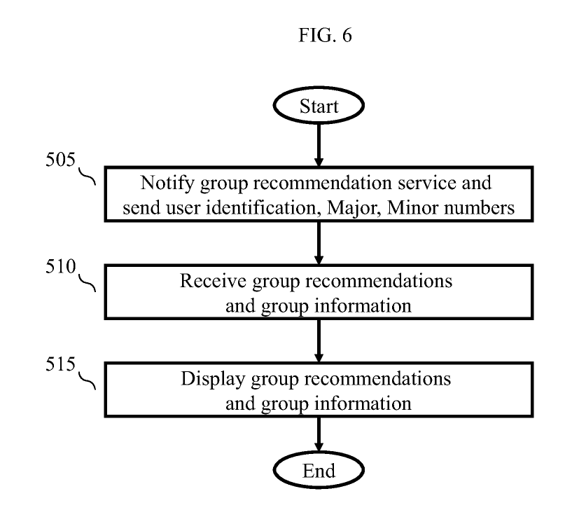

Turning now to FIG. 6, this shows a flow chart after the group recommendation application has been invoked by operating system 125 upon entering the range of beacon 251. In step 505, the group recommendation application notifies the group recommendation service (server 220) and sends the user identification (identifying both the user and mobile device 202) and the beacon identifier (Major 21 and Minor 22 of FIG. 2) via communications 130. In step 510, group recommendation application 120 receives any group recommendations from the group recommendation service and group information (e.g., group membership) while in the range of the beacon 251 via communications 130. In step 515, group recommendation application 120 displays any received group recommendations and group information to the user, who can then act on them if desired (e.g., purchase, view, or listen to the recommended item, etc.).

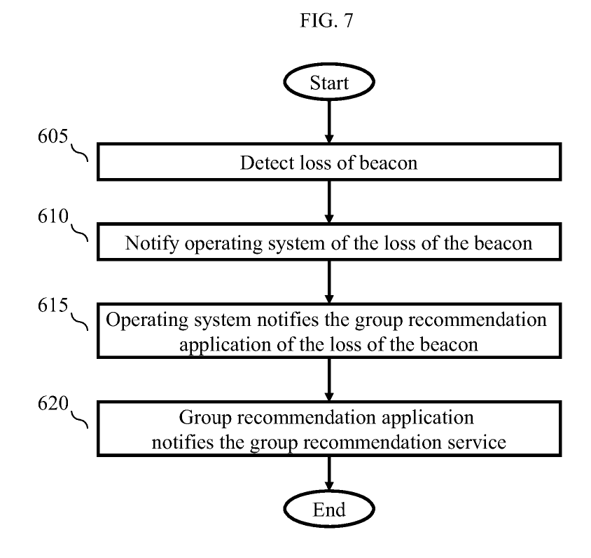

Moving to FIG. 7, this flow chart relates to when mobile device 202 leaves the range of beacon 251, i.e., is now physically outside of dashed circle 205. In step 605, sensor 105 detects the loss of beacon 251. In step 610, sensor 105 notifies operating system 125 that beacon 251 is no longer being detected. In step 615, operating system 125 notifies group recommendation application 120 of the loss of beacon 251. In step 620, group recommendation application 120 notifies the group recommendation service (server 220) that mobile device 202 has left the beacon group via communications 130.

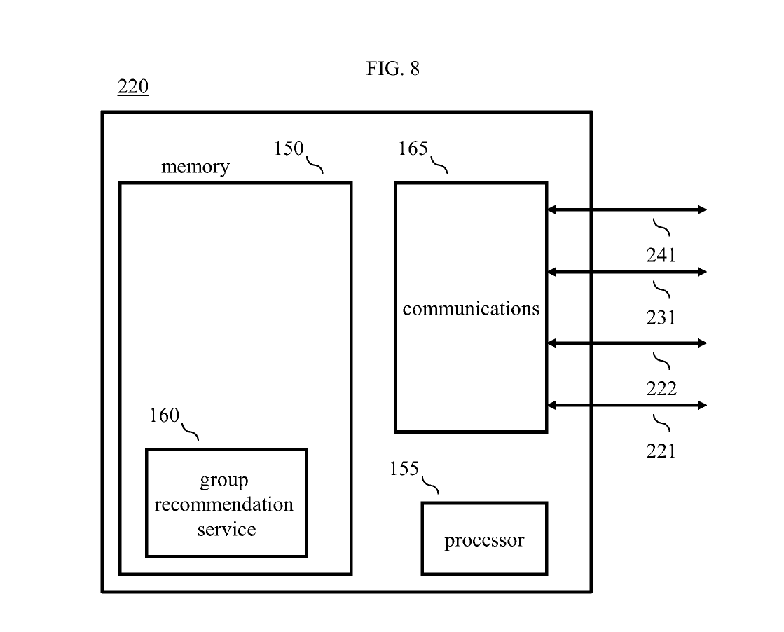

Turning now to server 220 of FIG. 1, other than the inventive concept, server 220 is a processor based system that communicates, e.g., via the internet, and has access to at least one database as represented in FIG. 1 by either database 230 or external social sites 240, e.g., Facebook social network. Turning briefly to FIG. 8, an illustrative high level block diagram of a server in accordance with the principles of the invention is shown. Server 220 is a processor based system as represented by processor 155. The latter represents one, or more, stored-program controlled processors as known in the art. In other words, processor 155 executes programs stored in memory 150. The latter represents volatile and/or non-volatile memory, e.g., hard disk, CD-ROM, DVD, random access memory (RAM), etc.) for storing program instructions and data, e.g., for performing the illustrative methods described further below. In this context, server 220 executes group recommendation service 160. Server 220 also has communications block 165, which supports communications of data over data connections 221, 222, 231 and 241 as known in the art. Data communications can be wired, or wireless, utilizing 802.11, 3G LTE, 4G LTE, etc.

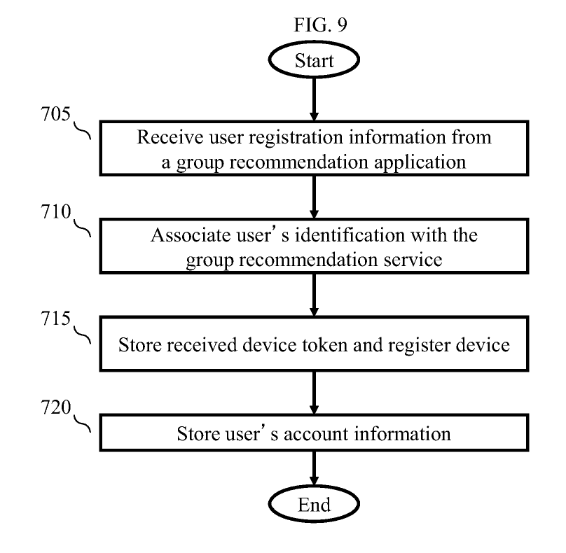

In this context, various flow charts will now be described for use in server 220 of FIG. 1 for the group recommendation service. The flow chart of FIG. 9 relates to when a user's device registers with server 220 for the group recommendation service (step 325 of FIG. 4). In step 705, server 220 receives user registration information from a group recommendation application running on a user's device (e.g., mobile device 202 of FIG. 1). In step 710, server 220 registers, or associates the user's identification with the group recommendation service. In step 715, server 220 stores the received device token associated with mobile device 202 and registers mobile device 202, e.g., for push notifications. Finally in step 720, server 220 stores the user's Facebook information. At this point, although not shown in FIG. 9, server 220 may also prefetch relevant Facebook information for the user for use at a later time.

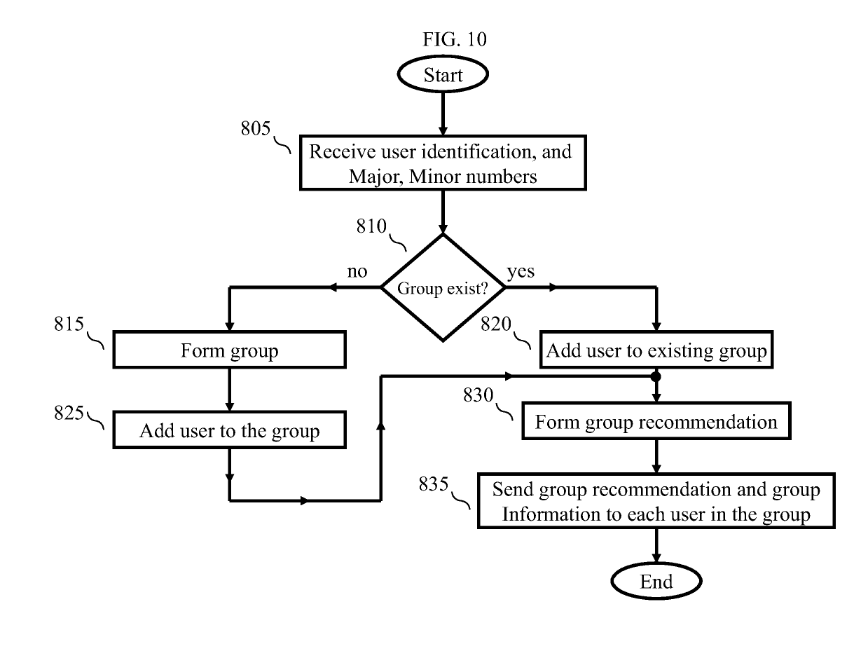

The flowchart of FIG. 10, relates to when a user's device notifies the group recommendation service that the user's device has detected a beacon associated with the group recommendation service. In step 805, server 220 receives an identification of the user and the beacon identifier for the received beacon in the user's device. In step 810, server 220 checks if a broadcast group (herein after simply “group”) already exists associated with the received beacon identifier. If a group does not exist, server 220 forms a group associated with the received beacon identifier in step 815. Then, in step 825, server 220 adds the user to the created group in step 825. However, if a group associated with the received beacon identifier already exists, server 220 adds the user to the existing group in step 820. In accordance with the principles of the invention, the group lists those users in physical proximity to each other. In other words, the actual physical location of the beacon host is irrelevant and, indeed, can be moved about as desired. Detection of the broadcast beacon associated with the group recommendation service is used to indicate proximity of users to each other. Once the user has been added to the group, server 220 forms a group recommendation in step 830 and sends the group recommendation and group information to each user in the group in step 835. It should be noted that a group can exist with just one person, e.g., the first time the group is formed in step 825, server 220 will still form the group recommendation but just use information for, in this example, the user associated with mobile device 202 in forming the group recommendation.

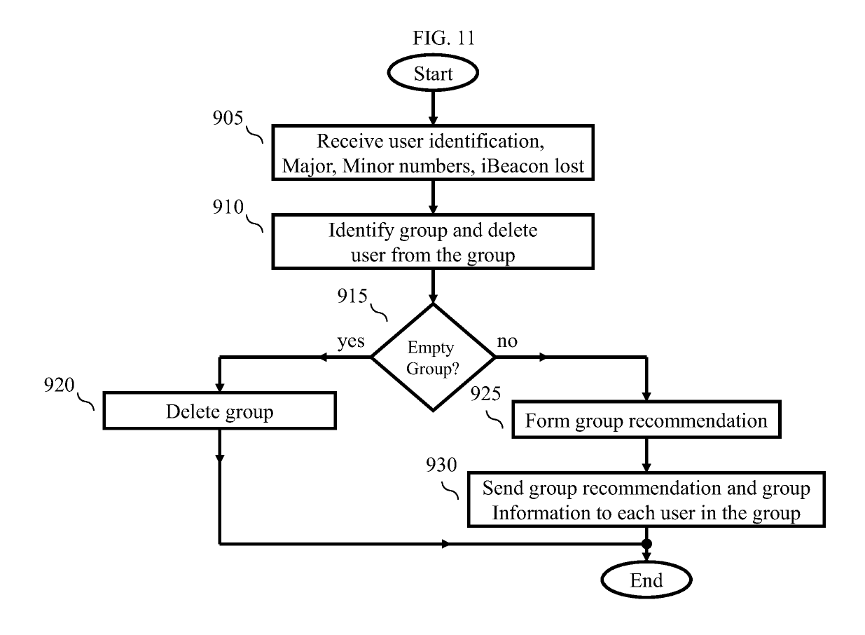

The flowchart of FIG. 11, relates to when a user's device notifies the group recommendation service that the user's device no longer detects a beacon associated with the group recommendation service. In step 905, server 220 receives an identification of the user and the beacon identifier from the received beacon in the user's device and information that the beacon has been lost. In step 910, server 220 identifies the group associated with the beacon identifier and deletes the user from the identified group. In step 915, server 220 checks if there are still users in the group. If the group is empty, i.e., no users are associated with the group, server 220 deletes the group. However, if there are still users in the group, server 220 forms a group recommendation in step 925 and sends the group recommendation and group information to the remaining users of the group in step 930. As such, whenever there is a change in membership of the group, a new group recommendation is sent to the users of the group as well as an update on the group information or membership.

As described above, server 220 maintains the state of all groups (such as what users are in each group) and notifies all users in the group of any changes in user makeup or recommendations for the group. As users enter and leave a group, the server will generate new recommendations based on the current users in the group and their collected preferences as illustrated in the flow charts of FIGS. 10 and 11. As such, server 220 is responsible for state management, rather than the individual devices. This is for a couple of reasons. First, initiating peer to peer communication with another device would require user intervention, whereas registering with a service can occur automatically in the background, even if the app is not running. Secondly, having devices connect to server 220 instead of directly to another user device allows the group recommendation service described herein to mitigate privacy and security concerns. Privacy, in that server 220 is responsible for reading and manipulating user data, then providing users, or clients, only with what is necessary; and security, since the user device will only be communicating with a trusted source. Finally, the management of the group by the server ensures that if a user leaves the group, the group still exists with the remaining users.

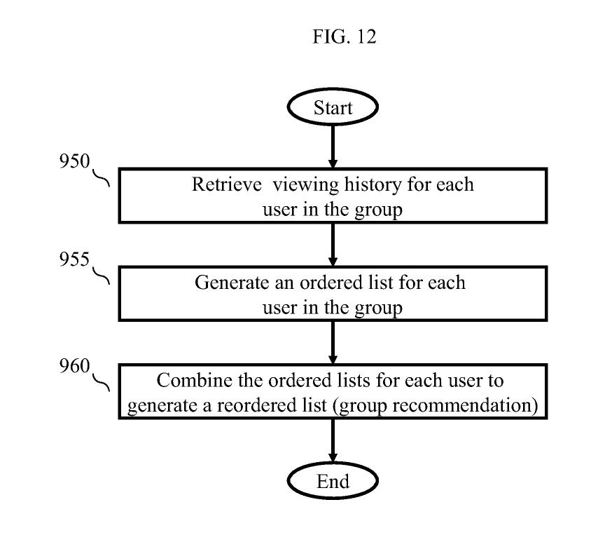

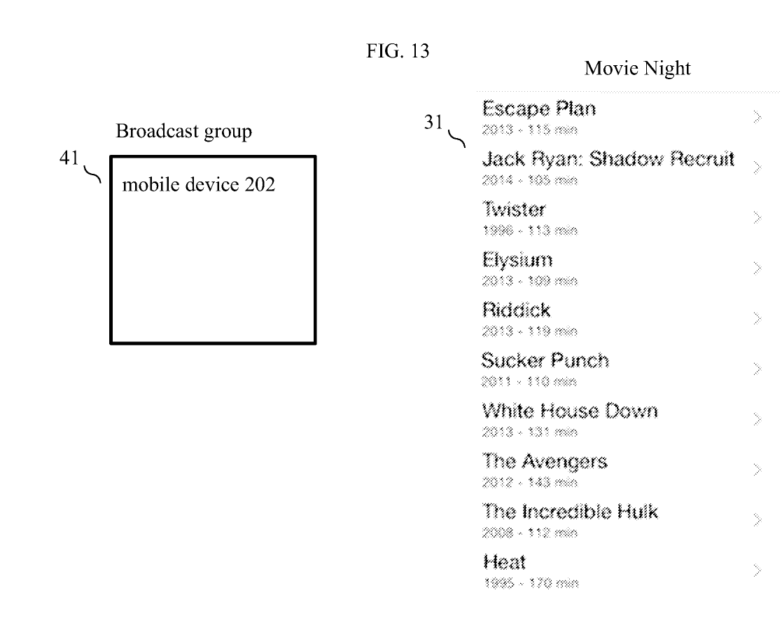

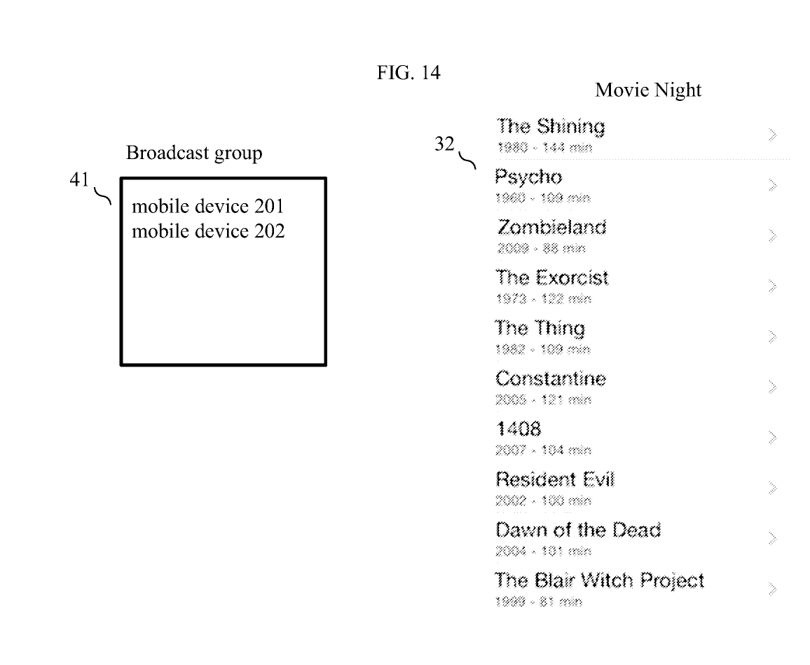

It should be noted that any group recommendation algorithm can be used to form the group recommendation in step 830 of FIG. 10 or step 925 of FIG. 11. An illustrative flow chart for one way of forming a group recommendation is shown in FIG. 12. In this flow chart it is assumed that the content being recommended is a movie and that external social sites 240 is, e.g., Facebook social network. It is also assumed that server 220 has access to the Netflix® streaming service. In this context, in step 950 of FIG. 12, server 220 retrieves the viewing history for each user in the group from their associated Facebook account in terms of “liked” and viewed movies that are currently available on Netflix. In step 955, server 220 generates an ordered list for each user by computing an expected rating for each movie based on the retrieved viewing history of each user, where, e.g., the highest rated movie is listed first and the lowest rated movie is listed last. An illustrative ordered list 31 is shown for display on mobile device 202 in FIG. 13 for that user. This is also the group recommendation if the only member of the group is the user associated with mobile device 202 as illustrated by the list of members in broadcast group 41, which is also available for display on mobile device 202. In step 960, server 220 combines the ordered lists for each user (e.g., the user associated with mobile device 201) to generate a reordered list, i.e., the group recommendation. Any number of methods can be used to combine the ordered lists for each user, e.g., the ratings can be averaged, the minimum of the ratings can be taken, etc. This is also known in the art as a transformation of the original ratings. Once the lists are combined into one list, the list is reordered to provide the group recommendation. An illustrative group recommendation 32 is shown for display on mobile device 202 in FIG. 14 for broadcast group 41, which now includes an additional user, i.e., both the users associated with mobile device 202 and mobile device 201.

As described above, and in accordance with the principles of the invention, a system uses physical proximity and at least one database (e.g., a social network) to provide movie recommendations for a group without any user interaction. Physical proximity is enabled by devices supporting detection of a beacon from a beacon broadcasting device. With this application, preferences and tastes of each individual user are utilized to identify what media content would be of interest to the group as a whole. Media content is, e.g., films/movies, TV shows (series or episode(s)), books, music, music videos, YouTube™ video community, video games, etc. In the illustrative embodiment, the group recommendation is provided to each user of the group to review, with options to learn more, purchase, and watch/listen using other applications. Other variations are possible. For example, another illustrative embodiment would integrate these recommendations into a streaming service itself, so that, e.g., upon turning the TV on, the group is immediately presented with the group's recommended content in a format native to the streaming service. It should also be noted that use of a proximity based system also is more flexible in that users do not need to be connected on any sort of social network in order to be within the same group.

Although the inventive concept was described in the context of Netflix, the inventive concept is not so limited and other streaming services may be used, e.g., MGO (movie streaming service), Spotify® music streaming service, and Rdio® music streaming service. Indeed, the group recommendation can relate to any likes/dislikes of the group, such as various forms of media content (described above) and even restaurants etc. In addition, the inventive concept is not limited to iBeacon location and proximity detection technology, e.g., other implementations using Bluetooth low energy or Near Field Communication (NFC) technology could also be used, etc. In addition, although illustrated in the context of a single channel (Facebook social network), the system is not so limited and can generate recommendations based on an aggregate of multiple channels. This contributes to the “seamless” nature of the system, as users take their existing preferences with them rather than having to build up a collection of media that they have consumed.

In view of the above, the foregoing merely illustrates the principles of the invention and it will thus be appreciated that those skilled in the art will be able to devise numerous alternative arrangements which, although not explicitly described herein, embody the principles of the invention and are within its spirit and scope. It is therefore to be understood that numerous modifications may be made to the illustrative embodiments and that other arrangements may be devised without departing from the spirit and scope of the present invention.

1. A method for providing a group recommendation, the method comprising:
detecting, in a device associated with a user, a beacon, which signals a group recommendation application;
executing the group recommendation application to send information from the device to a server, the information identifying the user and the beacon; and
receiving in the device from the server the group recommendation, wherein the group recommendation is associated with likes and/or dislikes of a collection of users that have registered with that beacon.

2. The method of claim 1, wherein the group recommendation is for media content.

3. The method of claim 2, wherein media content is at least one of a movie recommendation, TV recommendation, song recommendation and restaurant recommendation.

4. The method of claim 1, wherein the beacon conveys at least a first identifying element and a second identifying element, wherein the first identifying element is for use in identifying the group recommendation application and the second identifying element represents a broadcast source for the beacon.

5. The method of claim 4, wherein the first identifying element is a UUID number and the second identifying element is a combination of a Major number and Minor number.

6. The method of claim 1, wherein the beacon is a Bluetooth Low Energy signal.

7. The method of claim 1, wherein the device is one of a smartphone, portable music player, tablet, personal computer, game console, television, jukebox and settop box.

8. A device associated with a user, comprising:
a detector for detecting a beacon, the beacon signaling a group recommendation application;
a processor for executing the group recommendation application to send information from the device to a server, the information identifying the user and the beacon; and
a receiver for receiving a group recommendation from the server, wherein the group recommendation is associated with likes and/or dislikes of a collection of users that have registered with that beacon.

9. The device of claim 8, wherein the group recommendation is for media content.

10. The device of claim 9, wherein media content is at least one of a movie recommendation, TV recommendation, song recommendation and restaurant recommendation.

11. The device of claim 8, wherein the beacon conveys at least a first identifying element and a second identifying element, wherein the first identifying element is for use in identifying the group recommendation application and the second identifying element represents a broadcast source for the beacon.

12. The device of claim 11, wherein the first identifying element is a UUID number and the second identifying element is a combination of a Major number and Minor number.

13. The device of claim 8, wherein the beacon is a Bluetooth Low Energy signal.

14. The device of claim 8, wherein the device is one of a smartphone, portable music player, tablet, personal computer, game console, television, jukebox and settop box.

15. A method for use in a server, the method comprising:
receiving information from a user, the received information indicating detection of a broadcasting beacon associated with a group recommendation service;
associating the user with a broadcast group, the broadcast group being associated with the broadcasting beacon;
retrieving preferences for each user in the broadcast group from at least one database;
forming a group recommendation from the retrieved preferences; and
sending the group recommendation to each user in the broadcast group.

16. The method of claim 15, wherein the group recommendation is for media content.

17. The method of claim 16, wherein media content is at least one of a movie recommendation, TV recommendation, song recommendation and restaurant recommendation.

18. The method of claim 15, wherein the beacon conveys at least a first identifying element and a second identifying element, wherein the first identifying element is for use in identifying the group recommendation application and the second identifying element represents a broadcast source for the beacon.

19. The method of claim 18, wherein the first identifying element is a UUID number and the second identifying element is a combination of a Major number and Minor number.

20. The method of claim 15, wherein the at least one data base is a social network.

21. The method of claim 20, wherein the social network is at least one of Facebook or Google+.

22. Apparatus for providing a group recommendation service, the apparatus comprising:
a receiver for receiving information from a user, the received information indicating detection of a broadcasting beacon associated with a group recommendation service; and
a processor for (1) associating the user with a broadcast group, the broadcast group being associated with the broadcasting beacon, (2) retrieving preferences for each user in the broadcast group from at least one database, and (3) forming a group recommendation from the retrieved preferences for transmission to each user in the broadcast group.

23. The apparatus of claim 22, wherein the group recommendation is for media content.

24. The apparatus of claim 23, wherein media content is at least one of a movie recommendation, TV recommendation, song recommendation and restaurant recommendation.

25. The apparatus of claim 22, wherein the beacon conveys at least a first identifying element and a second identifying element, wherein the first identifying element is for use in identifying the group recommendation application and the second identifying element represents a broadcast source for the beacon.

26. The apparatus of claim 25, wherein the first identifying element is a UUID number and the second identifying element is a combination of a Major number and Minor number.

27. The apparatus of claim 22, wherein the at least one data base is a social network.

28. The apparatus of claim 27, wherein the social network is at least one of Facebook or Google+.
